(19) United States
(12) Patent Application Publication
(10) Pub. No.: US 2012/0198286 A1
(43) Pub. Date: Aug. 2, 2012

(54) COMMUNICATION APPARATUS, CONTROL METHOD, AND RECORDING MEDIUM

(75) Inventor: Hidetaka Koizumi, Kawasaki-shi (JP)

(73) Assignee: CANON KABUSHIKI KAISHA, Tokyo (JP)

(21) Appl. No.: 13/361,456

(22) Filed: Jan. 30, 2012

(30) Foreign Application Priority Data
Feb. 2, 2011 (JP) 2011-021187

(51) Int. Cl. G06F 11/00

(52) U.S. Cl. 714/45; 714/E11.02

(57) ABSTRACT

A communication apparatus includes a first unit that transmits predetermined data to an external apparatus, a second unit that transmits a command to the external apparatus, and a control unit that controls the second unit to transmit a first command and a second command to the external apparatus. The control unit controls the first unit not to transmit the predetermined data to the external apparatus if the external apparatus is not in a power-on state. Further, if the external apparatus is in the power-on state, the control unit controls the first unit to transmit the predetermined data to the external apparatus after the second command is transmitted to the external apparatus.

### BACKGROUND OF THE INVENTION

1. Field of the Invention

The present invention relates to a communication apparatus that can communicate with an external apparatus, a control method, and a recording medium.

2. Description of the Related Art

High-Definition Multimedia Interface (HDMI)® is one of conventionally proposed communication interfaces. A communication system conforming to the HDMI standard (hereinafter, referred to as an “HDMI system”) includes a source device and a sink device. The source device can transmit video data via an HDMI interface. The sink device can receive video data from the source device via the HDMI interface and can display the received video data.

Further, the HDMI system can use a command that conforms to the Consumer Electronics Control (CEC) standard (hereinafter, referred to as a “CEC command”). For example, the source device uses the CEC command to control the sink device.

A One Touch Play (hereinafter, referred to as “one-touch play”) function, which is defined according to the CEC standard, is usable to cause the sink device to display video data reproduced by the source device without operating the sink device. When the one-touch play function is used, the source device transmits an <Active Source> command (i.e., a command relating to the one-touch play function) to the sink device to control the sink device to display the video data received from the source device.

As discussed in Japanese Patent Application Laid-Open No. 2009-284374, there is a conventional source device that transmits the <Active Source> command to a sink device and acquires information required to generate video data to be transmitted to the sink device before transmitting the video data to the sink device.

The above-described conventional source device transmits video data to the sink device upon transmitting the <Active Source> command to the sink device even without confirming whether a power source of the sink device is in a state where the video data can be displayed.

Therefore, when the power source is not in the state where the video data can be displayed, the sink device does not display any video data transmitted from the source device. Thus, a user cannot view the video data generated by the source device on the sink device.

In this case, the user is additionally required to perform an operation to transmit the video data again from the source device to the sink device after the power source of the sink device turns into the state where the video data can be displayed.

### SUMMARY OF THE INVENTION

The present invention is directed to overcoming the above-described drawbacks and disadvantages. The present invention is directed to a source device which is capable of transmitting video data to a sink device from a source device after it is detected that a power source of the sink device is in a state where the video data can be displayed.

According to an aspect of the present invention, a communication apparatus includes a first unit that transmits predetermined data to an external apparatus, a second unit that transmits a command to the external apparatus, and a control unit that controls the second unit to transmit a first command and a second command to the external apparatus. If it is detected that the external apparatus is not in a power-on state, the control unit controls the first unit not to transmit the predetermined data to the external apparatus until the external apparatus is in the power-on state. If it is detected that the external apparatus is in the power-on state, the control unit controls the first unit to transmit the predetermined data to the external apparatus after the second command is transmitted to the external apparatus. The predetermined data includes at least one of video data and audio data. The first command is used for detecting a power state of the external apparatus, and the second command is used for controlling the external apparatus to output the predetermined data supplied from the first unit to the external apparatus.

According to another aspect of the present invention, there is provided a method for controlling a communication apparatus including a first unit that transmits predetermined data to an external apparatus and a second unit that transmits a command to the external apparatus. The method includes controlling the second unit to transmit a first command to the external apparatus, and controlling the second unit to transmit a second command to the external apparatus. If it is detected that the external apparatus is not in a power-on state, the method further includes controlling the first unit not to transmit the predetermined data to the external apparatus until the external apparatus is in the power-on state. If it is detected that the external apparatus is in the power-on state, the method further includes controlling the first unit to transmit the predetermined data to the external apparatus after the second command is transmitted to the external apparatus. The predetermined data includes at least one of video data and audio data. The first command is used for detecting a power state of the external apparatus, and the second command is used for controlling the external apparatus to output the predetermined data supplied from the first unit to the external apparatus.

According to a yet another aspect of the present invention, there is provided a computer readable recording medium storing a program that causes a computer to perform a method for controlling a communication apparatus including a first unit that transmits predetermined data to an external apparatus and a second unit that transmits a command to the external apparatus. The method includes controlling the second unit to transmit a first command to the external apparatus, controlling the second unit to transmit a second command to the external apparatus, controlling, if it is detected that the external apparatus is not in a power-on state, the first unit not to transmit the predetermined data to the external apparatus until the external apparatus is in the power-on state, controlling, if it is detected that the external apparatus is in the power-on state, the first unit to transmit the predetermined data to the external apparatus after the second command is transmitted to the external apparatus, wherein the predetermined data includes at least one of video data and audio data, the first command is used for detecting a power state of the external apparatus, and the second command is used for controlling the external apparatus to output the predetermined data supplied from the first unit to the external apparatus.

According to an exemplary embodiment of the present invention, a source device can transmit video data to a sink device after confirming the power-on state of the sink device so that the video data can be surely displayed on the sink device.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a communication system according to an exemplary embodiment of the present invention.

FIG. 2 is a block diagram illustrating an example configuration of the communication system according to an exemplary embodiment of the present invention.

FIG. 3 is a flowchart illustrating an example of a video switching process according to an exemplary embodiment of the present invention.

FIG. 4 is a flowchart illustrating an example of a first power status confirmation process according to an exemplary embodiment of the present invention.

FIG. 5 is a flowchart illustrating an example of a second power status confirmation process according to an exemplary embodiment of the present invention.

### DESCRIPTION OF THE EMBODIMENTS

Various exemplary embodiments, features, and aspects of the invention will be described in detail below with reference to the drawings.

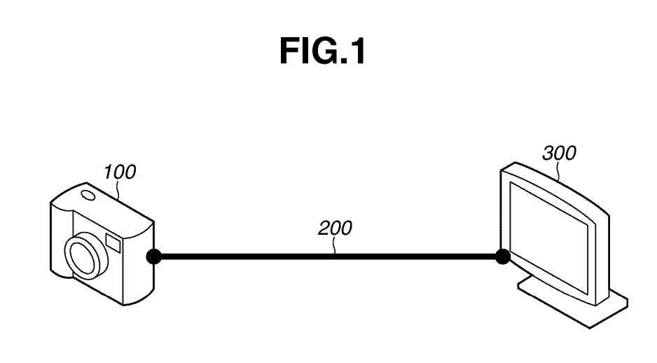

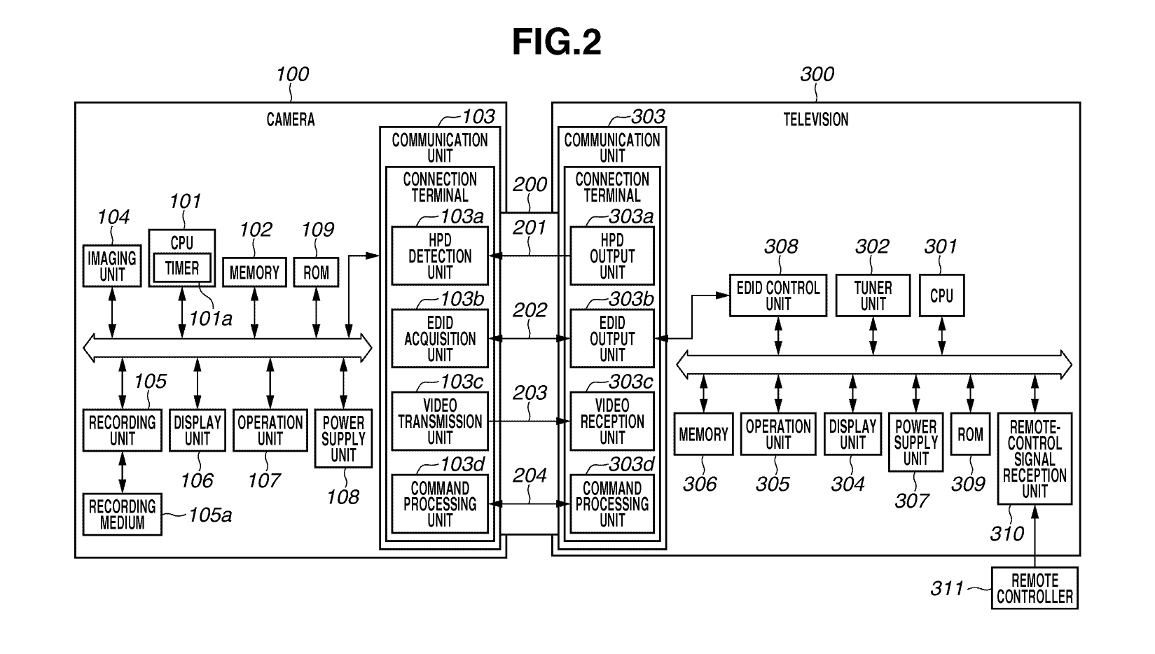

A communication system according to an exemplary embodiment of the present invention, as illustrated in FIG. 1 and FIG. 2, includes a communication apparatus 100, an external apparatus 300, and a connection cable 200. The communication apparatus 100 and the external apparatus 300 are connected via the connection cable 200.

The communication apparatus 100 is a data output apparatus that can transmit video data, audio data, and auxiliary data to the external apparatus 300 via the connection cable 200. The external apparatus 300 is a display apparatus that can display video data on a display device when the video data is received from the communication apparatus 100. Further, the external apparatus 300 can output audio data via a speaker when the audio data is received from the communication apparatus 100. The communication apparatus 100 can transmit and receive various control commands to and from the external apparatus 300 via the connection cable 200.

In the present exemplary embodiment, each of the communication apparatus 100, the external apparatus 300, and the connection cable 200 conforms to the High-Definition Multimedia Interface (HDMI) standard. Accordingly, the communication apparatus 100 is a source device that is functionally operable as an HDMI source conforming to the HDMI standard. The external apparatus 300 is a sink device that is functionally operable as an HDMI sink conforming to the HDMI standard.

In the present exemplary embodiment, each of the communication apparatus 100 and the external apparatus 300 conforms to the Consumer Electronics Control (CEC) protocol that is defined according to the HDMI standard. Control commands conforming to the CEC protocol can be transmitted from the communication apparatus 100 to the external apparatus 300 or vice versa. Hereinafter, each control command conforming to the CEC protocol is referred to as a “CEC command.”

In the present exemplary embodiment, a digital still camera is an example of the communication apparatus 100. However, the communication apparatus 100 is not limited to the digital still camera. Any other video output apparatus having the capability of functioning as an HDMI source, such as a digital single-lens reflex camera, a digital video camera, a recorder, or a digital versatile disc (DVD) player, is employable as the communication apparatus 100.

In the present exemplary embodiment, a television receiver (hereinafter, referred to as “television (TV)”) is an example of the external apparatus 300. However, the external apparatus 300 is not limited to the television. Any other display apparatus having the capability of functioning as an HDMI sink, such as a projector or a personal computer, is employable as the external apparatus 300.

In the following description, the communication apparatus 100 is referred to as a “camera 100” and the connection cable 200 is referred to as an “HDMI cable 200”, and further the external apparatus 300 is referred to as a “television 300.”

Next, the HDMI cable 200 is described below with reference to FIG. 2.

The HDMI cable 200 includes a +5V power line, a Hot Plug Detect (HPD) line 201, and a Display Data Channel (DDC) line 202. The HDMI cable 200 further includes a Transition Minimized Differential Signaling (TMDS) line 203 and a CEC line 204.

The +5V power line is an electric power supply line via which the camera 100 can supply electric power of +5V to the television 300. The HPD line 201 is a transmission line via which the television 300 can transmit an HPD signal of high-voltage level (hereinafter, H level) or low-voltage level (hereinafter, L level) to the camera 100. The DDC line 202 is a transmission line via which the television 300 can transmit device information of the television 300 to the camera 100. The device information of the television 300 is Extended Display Identification Data (EDID) or Enhanced EDID (E-EDID) of the television 300.

Each of EDID and E-EDID includes, as device information relating to the television 300, television identification information relating to the television 300, information relating to display capability of the television 300, and physical address (i.e., information indicating the connection terminal of the television 300). For example, each of EDID and E-EDID includes information relating to resolution, scanning frequency, aspect ratio, and color space that the television 300 can support.

E-EDID is an expanded version of EDID and includes information relating to a greater number of capabilities compared to EDID. For example, the E-EDID includes information relating to the format of video data and the format of audio data that the television 300 can support. Hereinafter, the EDID and the E-EDID are collectively referred to as “EDID.”

The TMDS line 203 is a transmission line via which the camera 100 can transmit video data, audio data, and auxiliary data to the television 300.

The CEC line 204 is a bidirectional transmission line via which the camera 100 can transmit and receive various CEC commands to and from the television 300. The television 300 can transmit a camera control CEC command to the camera 100 via the CEC line 204 to control the camera 100.

The connection cable 200 is not limited to the HDMI cable. Any other communication interface having the compatibility with the HDMI standard is employable. Further, the camera 100 and the television 300 can be configured to perform communications via a wireless network conforming to the HDMI standard.

Next, an example configuration of the camera 100 is described below with reference to FIG. 2.

As illustrated in FIG. 2, the camera 100 includes a central processing unit (CPU) 101, a memory 102, a communication unit 103, an imaging unit 104, a recording unit 105, a display unit 106, an operation unit 107, a power supply unit 108, and a read only memory (ROM) 109. Hereinafter, the camera 100 is described below in detail.

The CPU 101 can control various operations to be performed by the camera 100. Further, the CPU 101 can control the camera 100 according to a CEC command received from the television 300. The CPU 101 can control the camera 100 in response to a signal input via the operation unit 107. Further, the CPU 101 can analyze each EDID of the television 300 acquired from the television 300 and stores an analysis result in association with the acquired EDID in the memory 102.

The memory 102 is functionally operable as a buffer of the camera 100 and can temporarily store video data and audio data when the video and audio data are read by the recording unit 105.

Further, the memory 102 stores a physical address included in the EDID of the television 300 in addition to the analysis result of the EDID analyzed by the CPU 101. The physical address to be stored in the memory 102 is information indicating a connection terminal of the television 300 when the camera 100 is connected to the television 300 via the HDMI cable 200. The memory 102 is not limited to Random Access Memory (RAM) and can be an external storage apparatus, such as a hard disk drive.

The communication unit 103 includes an HPD detection unit 103a, an EDID acquisition unit 103b, a video transmission unit 103c, and a command processing unit 103d.

The communication unit 103 has a connection terminal to which the HDMI cable 200 is connectable.

The HPD detection unit 103a can detect an HPD signal when the HPD signal is transmitted from the television 300 via the HPD line 201. In a state where the camera 100 is supplying electric power of +5V to the television 300 via the +5V power line (not illustrated), the television 300 transmits an H-level HPD signal or an L-level HPD signal to the camera 100 based on a determination result whether the EDID of the television 300 can be transmitted to the camera 100.

If the television 300 can transmit the EDID of the television 300 to the camera 100 while electric power of +5V is supplied from the camera 100 to the television 300, the television 300 transmits the H-level HPD signal to the camera 100 via the HPD line 201. Hence, if the HPD detection unit 103a detects the H-level HPD signal, the HPD detection unit 103a sends a notification to the CPU 101 to inform that the EDID of the television 300 can be acquired from the television 300.

Further, in a state where the electric power of +5V is not supplied from the camera 100 to the television 300, the television 300 transmits the L-level HPD signal to the camera 100 via the HPD line 201. Further, if the television 300 cannot transmit the EDID of the television 300 to the camera 100 while the electric power of +5V is supplied from the camera 100 to the television 300, the television 300 transmits the L-level HPD signal to the camera 100 via the HPD line 201. Hence, if the HPD detection unit 103a detects the L-level HPD signal, the HPD detection unit 103a sends a notification to the CPU 101 to inform that the EDID of the television 300 cannot be acquired from the television 300.

If the HPD signal detected via the HPD line 201 is changed from H level to L level, the HPD detection unit 103a sends a notification to the CPU 101 to inform that the HPD signal has changed from H level to L level. Further, if the HPD signal is changed from L level to H level, the HPD detection unit 103a sends a notification to the CPU 101 to inform that the HPD signal has changed from L level to H level.

If the HPD signal detected by the HPD detection unit 103a is H level, the EDID acquisition unit 103b transmits an EDID acquisition request to the television 300 via the DDC line 202 and acquires the EDID of the television 300. If the HPD signal detected by the HPD detection unit 103a is L level, the EDID acquisition unit 103b does not transmit the EDID acquisition request to the television 300 via the DDC line 202 and does not acquire the EDID of the television 300.

The video transmission unit 103c can transmit video data to the television 300 via the TMDS line 203 when the video data is generated by the imaging unit 104 or read from a recording medium 105a by the recording unit 105. Further, the video transmission unit 103c can transmit audio data to the television 300 via the TMDS line 203 when the audio data is generated by a microphone unit (not illustrated) or read from the recording medium 105a by the recording unit 105. Further, the video transmission unit 103c can transmit auxiliary data to the television 300 via the TMDS line 203 if the auxiliary data is required when the television 300 displays video data or outputs audio data via the speaker thereof.

The command processing unit 103d can receive a CEC command if the CEC command is transmitted from the television 300 via the CEC line 204, and can supply the received CEC command to the CPU 101. In this case, the CPU 101 controls the camera 100 according to the CEC command supplied from the command processing unit 103d.

Further, the command processing unit 103d can transmit a CEC command for controlling the television 300 via the CEC line 204 to the television 300. The CPU 101 can generate the CEC command for controlling the television 300. After the CEC command for controlling the television 300 is transmitted to the television 300 via the CEC line 204, the command processing unit 103d receives a response from the television 300 if the response is supplied to the camera 100.

The response to be supplied from the television 300 to the camera 100 is, for example, an Ack response and a Nack response. If the command processing unit 103d transmits a CEC command to the television 300, the television 300 supplies either the Ack response or the Nack response to the camera 100 via the CEC line 204 to cause the camera 100 to check whether the CEC line 204 is valid. If the command processing unit 103d receives the Ack response, the CPU 101 determines that the CEC line 204 is valid. If the command processing unit 103d receives the Nack response, the CPU 101 determines that the CEC line 204 is invalid.

Further, the communication unit 103 can generate electric power of +5V when the communication unit 103 receives electric power supplied from the power supply unit 108. The communication unit 103 can supply the generated electric power of +5V to the television 300 via the +5V power line (not illustrated).

If the operational mode of the camera 100 is a shooting mode, the imaging unit 104 shoots an object and generates video data based on an optical image of the object. The imaging unit 104 has an image sensor, such as a charge-coupled device (CCD) sensor, which is configured to capture an object image. For example, the imaging unit 104 can generate moving image data or still image data as video data. The video data generated by the imaging unit 104 can be supplied from the imaging unit 104 to the video transmission unit 103c and the recording unit 105. If the EDID of the television 300 is transmitted from the television 300 to the EDID acquisition unit 103b, the imaging unit 104 converts the video data appropriately by taking the display capability of the television 300 into consideration so that video data having a suitable format can be supplied from the imaging unit 104 to the video transmission unit 103c.

When the imaging unit 104 generates moving image data, a microphone unit (not illustrated) generates audio data. The audio data generated by the microphone unit is supplied from the microphone unit to the video transmission unit 103c, the recording unit 105, and a speaker unit (not illustrated). If the EDID of the television 300 is received from the television 300, the microphone unit converts the audio data appropriately by taking the audio capability of the television 300 into consideration so that audio data having a suitable format can be supplied from the microphone unit to the video transmission unit 103c.

The audio data supplied from the microphone unit to the video transmission unit 103c can be transmitted to the television 300 via the TMDS line 203. The audio data supplied from the microphone unit to the recording unit 105 can be recorded on the recording medium 105a. If the operational mode of the camera 100 is a playback mode, the imaging unit 104 stops an image capturing operation and stops generating video data based on an optical image of the object.

If the operational mode of the camera 100 is the shooting mode, the recording unit 105 records the video data generated by the imaging unit 104 and the audio data generated by the microphone unit on the recording medium 105a. The CPU 101 controls the recording of the video data and the audio data generated by the imaging unit 104 and the microphone unit into the recording medium 105a according to a user instruction input via the operation unit 107. The CPU 101 can also control the recording of the video data and the audio data generated by the imaging unit 104 and the microphone unit into the recording medium 105a according to a CEC command received from the television 300.

Further, if the operational mode of the camera 100 is the playback mode, the recording unit 105 reads the recorded video/audio data from the recording medium 105a and supplies the readout video/audio data to the video transmission unit 103c and the display unit 106. The video/audio data to be recorded on the recording medium 105a by the recording unit 105 includes the video data generated by the imaging unit 104. Further, if the operational mode of the camera 100 is the shooting mode, the recording unit 105 stops the video/audio data reading operation.

The recording medium 105a is, for example, a built-in medium provided in the body of the camera 100 or a portable medium that is detachable from the body of the camera 100. Further, the data recorded on the recording medium 105a includes still image data and moving image data. Further, video data and audio data can be separately recorded on the recording medium 105a.

The display unit 106 can be constituted by an appropriate display device, such as a liquid crystal display device. If the operational mode of the camera 100 is the shooting mode, the display unit 106 displays the video data generated by the imaging unit 104. If the operational mode of the camera 100 is the playback mode, the recording unit 105 reproduces the video data from the recording medium 105a and the display unit 106 displays the reproduced video data.

The operation unit 107 can provide a user interface that enables users to operate the camera 100. The operation unit 107 has a plurality of buttons that are usable to operate the camera 100. Each button of the operation unit 107 can be constituted by a switch, a touch panel, or the like.

The power supply unit 108 can supply electric power of an AC power source, or a battery (not illustrated), to each unit of the camera 100. When the camera 100 is in a power-on state, the power supply unit 108 supplies required electric power to each unit of the camera 100. When the camera 100 is in a power-off state, the power supply unit 108 supplies electric power to the CPU 101 and the operation unit 107 and, if necessary, to the ROM 109.

Further, the communication unit 103 supplies electric power of +5V to the television 300 via the +5V power line (not illustrated) when the power supply unit 108 supplies electric power to the communication unit 103.

The ROM 109 stores a computer program that can be executed by the CPU 101 to control the camera 100. Further, the ROM 109 stores various parameters (including threshold values) relating to processes and operations to be performed by the camera 100. The ROM 109 can be replaced by another storage apparatus (e.g., a hard disk drive).

Next, an example configuration of the television 300 is described below with reference to FIG. 2.

As illustrated in FIG. 2, the television 300 includes a CPU 301, a tuner unit 302, a communication unit 303, a display unit 304, an operation unit 305, a memory 306, a power supply unit 307, an EDID control unit 308, a ROM 309, a remote-control signal reception unit 310, and a remote controller 311.

The CPU 301 can control various operations to be performed by the television 300 according to a computer program stored in the ROM 309. Further, the CPU 301 can control the power supply unit 307 to supply electric power to each unit and stop the electric power supply.

The tuner unit 302 can receive television broadcasting of a television channel selected by a user. The selection of a television channel can be performed using the operation unit 305 or the remote controller 311.

The memory 306 is functionally operable as a buffer of the television 300 and can temporarily store video data, audio data, and auxiliary data when these data are acquired by the communication unit 303. The memory 306 is not limited to Random Access Memory (RAM) and can be an external storage apparatus, such as a hard disk drive.

The communication unit 303 includes an HPD output unit 303a, an EDID output unit 303b, a video reception unit 303c, and a command processing unit 303d.

The communication unit 303 includes a connection terminal to which the HDMI cable 200 is connectable.

The HPD output unit 303a can transmit an HPD signal to the camera 100 via the HPD line 201.

The communication unit 303 determines whether the camera 100 is supplying electric power of +5V to the television 300 via the +5V power line if the television 300 selects the connection terminal that is connected to the camera 100 via the HDMI cable 200.

Further, the HPD output unit 303a can transmit an H-level HPD signal or an L-level HPD signal to the camera 100 via the HPD line 201 based on a determination result obtained by the communication unit 303.

If the communication unit 303 determines that the camera 100 is supplying electric power of +5V via the +5V power line, the EDID control unit 308 determines whether the EDID of the television 300 stored in the ROM 309 can be transmitted to the camera 100 via the DDC line 202. The EDID of the television 300 corresponding to each connection terminal is separately stored in the ROM 309. If information included in the EDID corresponding to the connection terminal that is connected to the camera 100 has not been changed, the EDID control unit 308 determines that the EDID of the television 300 corresponding to the connection terminal that is connected to the camera 100 can be transmitted to the camera 100. In this case, the CPU 301 controls the HPD output unit 303a to transmit the H-level HPD signal to the camera 100 to inform the camera 100 that the EDID of the television 300 can be transmitted to the camera 100 in response to an EDID request from the camera 100. The EDID request is a request for acquiring the EDID of the television 300.

If the information included in the EDID corresponding to the connection terminal that is connected to the camera 100 has been changed, the EDID control unit 308 determines that the EDID of the television 300 corresponding to the connection terminal that is connected to the camera 100 cannot be transmitted to the camera 100. In this case, the CPU 301 controls the HPD output unit 303a to transmit the L-level HPD signal to the camera 100 to inform the camera 100 that the EDID of the television 300 cannot be transmitted to the camera 100 in response to the EDID request from the camera 100.

Further, if the communication unit 303 determines that electric power of +5V is not supplied from the camera 100 via the +5V power line, the CPU 301 controls the HPD output unit 303a to transmit the L-level HPD signal to the camera 100 via the HPD line 201.

The communication unit 303 determines whether a source device other than the camera 100 is supplying electric power of +5V to the television 300 via the +5V power line if the television 300 selects a connection terminal that is connected to the source device other than the camera 100. Further, the HPD output unit 303a can transmit an H-level HPD signal or an L-level HPD signal to the source device other than the camera 100 via the HPD line based on a determination result obtained by the communication unit 303.

However, in this case, the connection terminal connected to the camera 100 is not selected by the television 300. Therefore, the communication unit 303 does not determine whether the camera 100 is supplying electric power of +5V to the television 300. In this case, the CPU 301 controls the HPD output unit 303a to transmit the L-level HPD signal to the camera 100 because the connection terminal connected to the camera 100 is not selected. Thus, the CPU 301 notifies the camera 100 of not transmitting the EDID of the television 300 to the camera 100 even when the EDID request is transmitted from the camera 100.

The television 300 includes a unique physical address having been set for each connection terminal. Information indicating the unique physical address having been set for each connection terminal is included in the EDID.

The physical address is information defined according to the HDMI standard and indicates a communication path of each device provided in the communication system.

When the HPD output unit 303a transmits an H-level HPD signal via the HPD line 201, the EDID output unit 303b determines whether the camera 100 has transmitted the EDID acquisition request to the television 300 via the DDC line 202.

If the HPD signal transmitted by the HPD output unit 303a is H level and the EDID acquisition request is transmitted to the television 300 from the camera 100, the EDID output unit 303b transmits the EDID of the television 300 to the camera 100 via the DDC line 202.

When the EDID output unit 303b receives the EDID acquisition request transmitted from the camera 100 to the television 300, the EDID output unit 303b notifies the CPU 301 of having received the EDID acquisition request transmitted from the camera 100 to the television 300. Further, when the EDID output unit 303b receives the EDID acquisition request transmitted from a source device other than the camera 100 to the television 300, the EDID output unit 303b notifies the CPU 301 of having received the EDID acquisition request transmitted from the source device other than the camera 100 to the television 300.

If the HPD signal transmitted by the HPD output unit 303a is L level, the EDID output unit 303b does not transmit the EDID of the television 300 to the camera 100 even when the EDID acquisition request is transmitted from the camera 100 to the television 300.

When the EDID of the television 300 is read out of the ROM 309 by the EDID control unit 308 and supplied to the EDID output unit 303b, the EDID output unit 303b transmits the EDID of the television 300 to the camera 100 via the DDC line 202.

The video reception unit 303c receives video data, audio data, and auxiliary data via the TMDS line 203 when each data is transmitted from the camera 100.

When the television 300 selects the connection terminal connected to the camera 100 via the HDMI cable 200, the video reception unit 303c stores the video data received from the camera 100 via the TMDS line 203 in the memory 306 and displays the received video data on the display unit 304. In this case, the video reception unit 303c stores the audio data received from the camera 100 via the TMDS line 203 in the memory 306 and output the received audio data via the speaker unit (not illustrated). Further, in this case, the video reception unit 303c supplies the auxiliary data received from the camera 100 via the TMDS line 203 to the CPU 301. The CPU 301 controls the television 300 according to the auxiliary data received from the camera 100.

When the television 300 selects another connection terminal connected to a source device other than the camera 100, the display unit 304 does not display any video data even when the video data is received from the camera 100 via the TMDS line 203. In this case, the communication unit 303 does not output any audio data from the speaker unit (not illustrated) even when the audio data is received from the camera 100 via the TMDS line 203. More specifically, if video data is received from another source device, the communication unit 303 displays the received video data on the display unit 304. If audio data is received from another source device, the communication unit 303 outputs the received audio data via the speaker unit.

The command processing unit 303d can receive a CEC command if the CEC command is transmitted from the camera 100 via the CEC line 204. The command processing unit 303d supplies the CEC command received from the camera 100 to the CPU 301. The CPU 301 controls the television 300 according to the CEC command transmitted from the camera 100 to the command processing unit 303d.

Further, the command processing unit 303d can supply the Ack response or the Nack response to the camera 100 via the CEC line 204 according to the CEC command received from the camera 100. Further, the command processing unit 303d can transmit a CEC command for controlling the camera 100 via the CEC line 204 to the camera 100. The CEC command for controlling the camera 100 can be generated by the CPU 301 and supplied from the CPU 301 to the command processing unit 303d.

Even when the television 300 selects another connection terminal connected to a source device other than the camera 100, the command processing unit 303d can receive a CEC command transmitted from the camera 100 via the CEC line 204.

The total number of the HDMI cable connection terminals of the communication unit 303 is an arbitrary value (e.g., 2 or more) that can be determined considering the performances of the television 300. Further, if any available connection terminal remains, a source device other than the camera 100 can be additionally connected to the television 300 via the HDMI cable.

The display unit 304 can be constituted by an appropriate display device, such as a liquid crystal display device. The display unit 304 can display video data if the video data is supplied from at least one of the tuner unit 302 and the communication unit 303. If the communication unit 303 receives any video data from the camera 100, the display unit 304 displays the video data supplied from the camera 100.

The operation unit 305 can provide a user interface that enables users to operate the television 300. The operation unit 305 has a plurality of buttons that are usable to operate the television 300. The CPU 301 can control the television 300 according to a user instruction input via the operation unit 305. Each button of the operation unit 305 can be constituted by a switch, a touch panel, or the like. The operation unit 305 includes various types of buttons (e.g., a power button, a channel selection button, and an external input button) that are usable to operate the television 300.

The power supply unit 307 can supply electric power of an AC power source or the like to each unit of the television 300. When the power state of the television 300 is a power-on state, the power supply unit 307 supplies required electric power to each unit of the television 300.

When the power state of the television 300 is the power-on state, the display unit 304 can display either the video data received by the communication unit 303 or the video data received by the tuner unit 302. Further, when the power state of the television 300 is the power-on state, the speaker unit (not illustrated) can output the audio data received by the communication unit 303 or the audio data received by the tuner unit 302.

When the power state of the television 300 is a standby state, electric power is supplied from the power supply unit 307 to each of the CPU 301, the operation unit 305, and the communication unit 303. However, no electric power is supplied from the power supply unit 307 to a device other than the CPU 301, the operation unit 305, the communication unit 303, and the remote-control signal reception unit 310.

Further, it is useful that the power supply unit 307 supplies electric power to the ROM 309 even when the power state of the television 300 is the standby state. When the power state of the television 300 is the standby state, both the video data received by the communication unit 303 and the video data received by the tuner unit 302 are not displayed by the display unit 304. Further, when the power state of the television 300 is the standby state, both the audio data received by the communication unit 303 and the audio data received by the tuner unit 302 are not output from the speaker unit (not illustrated).

If in the television 300 it is informed that the EDID output unit 303b has received the EDID acquisition request from the camera 100 or other source device, the EDID control unit 308 determines whether information included in the EDID of the television 300 corresponding to the received request has been changed.

If the information included in the EDID of the television 300 has not been changed, the EDID control unit 308 reads the EDID of the television 300 that corresponds to a connection terminal connected to an apparatus that has transmitted the request, from the ROM 309, according to the EDID acquisition request. The EDID control unit 308 supplies the EDID of the television 300 having been read from the ROM 309 to the EDID output unit 303b.

If the information included in the EDID of the television 300 has changed, the EDID control unit 308 transmits an L-level HPD signal via the connection terminal connected to the apparatus that has transmitted the request. In this case, the EDID control unit 308 does not transmit any EDID of the television 300 to the apparatus that has transmitted the request.

The ROM 309 stores the computer program to be executed by the CPU 301 to control the television 300. Further, the ROM 309 stores various parameters (including threshold values) relating to processes ad operations to be performed by the television 300. The ROM 309 can be replaced by another storage apparatus (e.g., a hard disk drive).

If a control signal is received from the remote controller 311, the remote-control signal reception unit 310 supplies the received control signal to the CPU 301. Thus, if a user instruction is input via the remote controller 311, the CPU 301 can receive the user instruction via the remote controller 311 and the remote-control signal reception unit 310. The CPU 301 can control at least one of the television 300 and the camera 100 according to the control signal received by the remote-control signal reception unit 310.

When the camera 100 is controlled based on the control signal received by the remote-control signal reception unit 310, the CPU 301 generates a CEC command that corresponds to the control signal supplied from the remote-control signal reception unit 310 and supplies the generated CEC command to the command processing unit 303d. The CEC command supplied to the command processing unit 303d is transmitted to the camera 100 via the CEC line 204. Thus, users can control the camera 100 with the remote controller 311. In the present exemplary embodiment, it is assumed that the remote controller 311 is usable to control the camera 100 via the television 300.

The remote controller 311 provides a user interface that enables users to operate the camera 100 and the television 300. The remote controller 311 has a plurality of buttons that are usable to operate the camera 100 and a plurality of buttons that are usable to operate the television 300. Each button of the remote controller 311 can be constituted by a switch, a touch panel, or the like.

The remote controller 311 includes various types of buttons (e.g., a power button, a channel selection button, an external input button, a menu button, a +button, a −button, and a SET button) that are usable to operate the television 300.

The channel selection button is a button usable to select a television channel to be received by the tuner unit 302. The external input button is a button usable to select either the video data included in the television broadcasting received by the tuner unit 302 or the video data received from the communication unit 303 and display the selected video data on the display unit 304.

The remote controller 311 further includes various types of buttons (e.g., a playback button, a stop button, a pause button, a fast-forwarding button, a rewinding button, a start/stop button, and a menu button) that are usable to operate the camera 100.

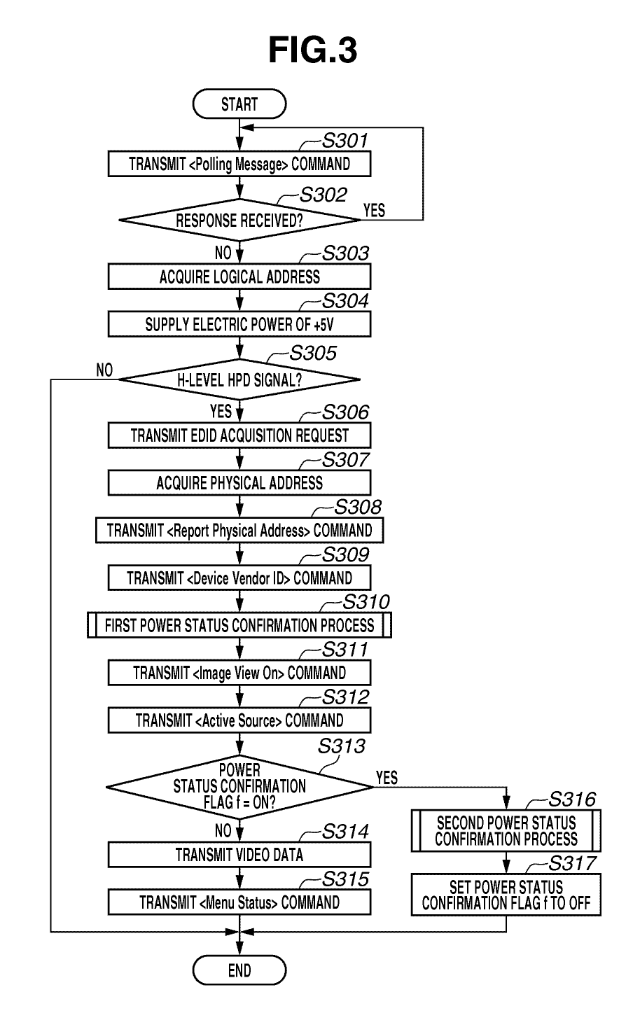

Next, a video switching process that can be performed by the camera 100 in the power-on state is described below with reference to FIG. 3. FIG. 3 is a flowchart illustrating an example of the video switching process that can be performed by the camera 100 according to the present exemplary embodiment. The video switching process is a process that can be performed by the camera 100 to control the television 300 to cause the television 300 to select the connection terminal connected to the camera 100 to cause the television 300 to display video data transmitted from the camera 100 to the television 300.

The camera 100 performs the video switching process in a power state where the camera 100 can communicate with the television 300 via the HDMI cable 200.

The CPU 101 is required to acquire a logical address of the camera 100 to control the television 300 according to a CEC command. To acquire the logical address of the camera 100, the CPU 101 is required to identify a logical address not yet acquired for an apparatus other than the camera 100 that is present in the communication system, of a plurality of logical addresses defined according to the HDMI standard.

In step S301, the CPU 101 controls the command processing unit 103d to transmit a <Polling Message> command that includes a logical address to the television 300 via the CEC line 204.

The <Polling Message> command is one of the CEC commands, which is a command usable to check whether an apparatus that already has the logical address included in the <Polling Message> command is present in the communication system. The logical address included in the <Polling Message> command is one of a plurality of logical addresses defined according to the HDMI standard.

If the command processing unit 103d has transmitted the <Polling Message> command to the television 300 via the CEC line 204, the process proceeds from step S301 to step S302 in the flowchart illustrated in FIG. 3.

If the television 300 has received the <Polling Message> command transmitted in step S301, the television 300 transmits either the Ack response or the Nack response to the camera 100 in response to the <Polling Message> command. The camera 100 can determine whether the camera 100 can acquire a logical address when the response to the <Polling Message> command is received from the television 300.

In step S302, the CPU 101 determines whether the logical address can be acquired by checking if the response to the <Polling Message> command transmitted by the command processing unit 103d in step S301 has been received. If the command processing unit 103d has received the response to the <Polling Message> command from the television 300, the CPU 101 determines that the logical address included in the <Polling Message> command is already acquired by other apparatus. In this case, the CPU 101 determines that the logical address included in the <Polling Message> command cannot be acquired as the logical address of the camera 100. If the CPU 101 determines that the command processing unit 103d has received the response to the <Polling Message> command (YES in step S302), the process returns from step S302 to step S301.

When the CPU 101 performs the process in step S301 again, the CPU 101 controls the command processing unit 103d to transmit a <Polling Message> including another logical address (different from the logical address included in the <Polling Message> command already transmitted to the television 300) to the television 300. By repeating the above-described processes, the CPU 101 identifies a logical address that is not acquired by an apparatus other than the camera 100 in the communication system and the camera 100 can acquire.

If the command processing unit 103d has not received any response to the <Polling Message> command from the television 300, the CPU 101 determines that the logical address included in the <Polling Message> command is not yet acquired by other apparatus. In this case, the CPU 101 determines that the logical address included in the <Polling Message> command can be acquired as the logical address of the camera 100. If the CPU 101 determines that the command processing unit 103d has not received the response to the <Polling Message> command (NO in step S302), the process proceeds from step S302 to step S303.

If the command processing unit 103d has not received the response to the <Polling Message> command from the television 300 a predetermined number of times, the CPU 101 determines that the logical address included in the <Polling Message> command is not yet acquired by other apparatus. In this case, the CPU 101 can determine that the logical address included in the <Polling Message> command can be acquired as the logical address of the camera 100.

In step S303, the CPU 101 stores the logical address included in the <Polling Message> command (having received no response), as the logical address of the camera 100, in the memory 102. Thus, the camera 100 can acquire the logical address of the camera 100. After the storage of the logical address of the camera 100 into the memory 102 is completed, the process proceeds from step S303 to step S304.

In step S304, the CPU 101 controls the communication unit 103 to supply electric power of +5V from the camera 100 to the television 300 via the +5V power line (not illustrated).

If the communication unit 103 has transmitted electric power of +5V to the television 300, the process proceeds from step S304 to step S305.

In step S305, the CPU 101 determines whether the HPD detection unit 103a has detected an H-level HPD signal.

If the CPU 101 determines that the HPD detection unit 103a has detected the H-level HPD signal (YES in step S305), the process proceeds from step S305 to step S306.

If the CPU 101 determines that the HPD detection unit 103a has not detected the H-level HPD signal (NO in step S305), the CPU 101 terminates the process of the flowchart illustrated in FIG. 3. Similarly, if the CPU 101 determines that the HPD detection unit 103a has detected the L-level HPD signal, the CPU 101 terminates the process of the flowchart illustrated in FIG. 3.

In step S306, the CPU 101 controls the EDID acquisition unit 103b to transmit the EDID acquisition request to the television 300 via the DDC line 202.

The television 300 receives an EDID request transmitted from the camera 100 while the television 300 is transmitting the H-level HPD signal to the camera 100. The television 300 transmits the EDID of the television 300 that corresponds to the EDID request to the camera 100 via the DDC line 202. Therefore, the CPU 101 waits for a predetermined time so that the EDID acquisition unit 103b can acquire the EDID of the television 300.

If the CPU 101 determines that the EDID acquisition unit 103b has acquired the EDID of the television 300, the CPU 101 analyzes the EDID of the television 300 supplied from the EDID acquisition unit 103b. Further, the CPU 101 stores the analysis result of the EDID of the television 300 and the EDID of the television 300 supplied from the EDID acquisition unit 103b in the memory 102. After the analysis result of the EDID of the television 300 and the EDID of the television 300 supplied from the EDID acquisition unit 103b have been stored in the memory 102, the process proceeds from step S306 to step S307.

If the CPU 101 determines that the EDID acquisition unit 103b has not acquired the EDID of the television 300 while the predetermined time elapses, the CPU 101 terminates the process of the currently executed flowchart illustrated in FIG. 3.

In step S307, the CPU 101 acquires a physical address included in the EDID of the television 300 with reference to the analysis result of the EDID of the television 300 stored in the memory 102 in step S306. Further, the CPU 101 stores the physical address acquired from the analysis result of the EDID of the television 300, as physical address of the camera 100, in the memory 102. After the physical address of the camera 100 is stored in the memory 102, the process proceeds from step S307 to step S308.

In step S308, the CPU 101 controls the command processing unit 103d to transmit a <Report Physical Address> command to the television 300 via the CEC line 204.

The <Report Physical Address> command is one of the CEC commands, which is a command usable to notify each apparatus existing in the communication system of the logical address of the camera 100 and the physical address of the camera 100. Therefore, the <Report Physical Address> command includes the logical address of the camera 100 and the physical address of the camera 100.

The logical address of the camera 100 included in the <Report Physical Address> command is a logical address stored in the memory 102. Further, the physical address of the camera 100 included in the <Report Physical Address> command is a physical address stored in the memory 102.

If the <Report Physical Address> command is transmitted by the command processing unit 103d to the television 300 via the CEC line 204, the process proceeds from step S308 to step S309.

In step S309, the CPU 101 controls the command processing unit 103d to transmit a <Device Vendor ID> command including a Vendor ID of the camera 100 (hereinafter, referred to as “vendor ID”) to the television 300 via the CEC line 204.

The <Device Vendor ID> command is one of the CEC commands, which is a command usable to notify each apparatus existing in the communication system of the vendor ID of the camera 100. The vendor ID is identification information unique to each maker. If there is a plurality of apparatuses having the same vendor ID in the communication system, the apparatuses having the same vendor ID can perform specific processes and operations defined by the maker.

However, if vendor IDs of two or more apparatuses are different from each other, each apparatus cannot perform specific processes and operations defined by another maker although they can perform general processes and operations defined according to the CEC standard. In the present exemplary embodiment, the vendor ID of the camera 100 included in the <Device Vendor ID> command is stored beforehand in the ROM. 109.

If the <Device Vendor ID> command is transmitted by the command processing unit 103d to the television 300 via the CEC line 204, the process proceeds from step S309 to step S310.

In a state where the power state of the television 300 is the standby state, even if the television 300 receives video data transmitted from the camera 100, the television 300 does not display the video data received from the camera 100 on the display unit 304 until the power state of the television 300 turns into the power-on state. Therefore, even if the camera 100 transmits video data to the television 300 to display the video data on the display unit 304 of the television 300, the video data transmitted from the camera 100 cannot be displayed on the television 300 until the power state of the television 300 turns into the power-on state.

Hence, before the video transmission unit 103c transmits video data to the television 300, the CPU 101 determines whether to transmit the video data to the television 300 after confirming whether the power state of the television 300 is the power-on state.

In step S310, the CPU 101 performs a first power status confirmation process. The first power status confirmation process is a process to be performed by the camera 100 to confirm whether the power source of the television 300 is in the power-on state before transmitting a CEC command to the television 300 to cause the television 300 to display the video data supplied from the camera 100. In the present exemplary embodiment, the CPU 101 performs the first power status confirmation process before the camera 100 transmits the video data to the television 300.

The first power status confirmation process is described in detail below.

After the first power status confirmation process is performed by the CPU 101, the process proceeds from step S310 to step S311.

In step S311, the CPU 101 controls the command processing unit 103d to transmit an <Image View On> command to the television 300 via the CEC line 204.

The <Image View On> command is one of the CEC commands, which is a command usable to bring the television 300 into the power-on state so that the transmitted video data can be displayed on the display unit 304 of the television 300.

If the <Image View On> command is transmitted by the command processing unit 103d to the television 300 via the CEC line 204, the process proceeds from step S311 to step S312.

In step S312, the CPU 101 controls the command processing unit 103d to transmit an <Active Source> command including the physical address of the camera 100 to the television 300 via the CEC line 204.

The <Active Source> command is one of the CEC commands, which is a command usable to notify each apparatus existing in the communication system of the validity of the physical address of the camera 100. When the television 300 has received the <Active Source> command including the physical address of the camera 100, the television 300 is controlled to select the connection terminal that corresponds to the physical address of the camera 100. In this case, video data transmitted from the camera 100 to the television 300 can be supplied to the display unit 304 of the television 300. Further, audio data transmitted from the camera 100 to the television 300 can be supplied to the speaker unit (not illustrated) of the television 300.

If the <Active Source> command is transmitted by the command processing unit 103d to the television 300 via the CEC line 204, the process proceeds from step S312 to step S313.

In step S313, the CPU 101 determines whether a power status confirmation flag f stored in the memory 102 is set to ON. The power status confirmation flag f is a flag that causes the CPU 101 to determine whether the camera 100 is required to perform a second power status confirmation process as process to confirm the power state of the television 300.

If the CPU 101 determines that the power status confirmation flag f stored in the memory 102 is set to ON (YES in step S313), the CPU 101 determines that performing the second power status confirmation process is necessary as process to confirm the power state of the television 300. In this case (YES in step S313), the process proceeds from step S313 to step S316.

If the CPU 101 determines that the power status confirmation flag f stored in the memory 102 is not set to ON (NO in step S313), the CPU 101 determines that performing the second power status confirmation process is not necessary as a process to confirm the power state of the television 300. In this case (NO in step S313), the process proceeds from step S313 to step S314.

In step S314, the CPU 101 controls the video transmission unit 103c to transmit the video data from the camera 100 to the television 300 via the TMDS line 203.

After the video transmission unit 103c has started transmitting the video data to the television 300, the process proceeds from step S314 to step S315.

In step S315, the CPU 101 controls the command processing unit 103d to transmit a <Menu Status> command including information indicating that a menu of the camera 100 is activated to the television 300 via the CEC line 204.

The <Menu Status> command including the information indicating that a menu of the camera 100 is activated is one of the CEC commands, which is a command usable when a user operates the remote controller 311 of the television 300 to cause the camera 100 to perform a predetermined process.

In the present exemplary embodiment, the predetermined process is defined by a remote controller code that corresponds to a button of the remote controller 311 operated by a user.

When the television 300 has received the <Menu Status> command and the remote controller 311 is operated, the television 300 transmits the CEC command for controlling camera to the camera 100 so that the camera 100 can perform remote controller code process corresponding to the operated button of the remote controller 311.

When the CPU 301 has received the <Menu Status> command, the CPU 301 controls the command processing unit 303d to transmit a CEC command to the camera 100 to cause the camera 100 to reproduce video data if the playback button of the remote controller 311 is operated. Further, when the CPU 301 has received the <Menu Status> command, the CPU 301 controls the command processing unit 303d to transmit a CEC command to the camera 100 to cause the camera 100 to record video data if a recording button of the remote controller 311 is operated.

When the CPU 301 has not received the <Menu Status> command, the CPU 301 prevents the camera 100 from performing the remote controller code process that corresponds to the operated button of the remote controller 311 even when the remote controller 311 is operated. In this case, the CPU 301 controls the command processing unit 303d to prevent the CEC command from being transmitted to the camera 100 so that the camera 100 does not perform the remote controller code process that corresponds to the operated button of the remote controller 311.

The CPU 301 performs similar process when the information indicating that the menu of the camera 100 is not activated is not included in the <Menu Status> command. In this case, the CPU 301 controls the command processing unit 303d to prevent the CEC command from being transmitted to the camera 100 so that the camera 100 does not perform the remote controller code process that corresponds to the operated button of the remote controller 311 even when the remote controller 311 is operated.

If the <Menu Status> command including the information indicating that the menu of the camera 100 is activated by the command processing unit 103d to the television 300 via the CEC line 204, the CPU 101 terminates the process of the flowchart illustrated in FIG. 3.

In step S316, the CPU 101 performs the second power status confirmation process. The second power status confirmation process is a process to be performed by the camera 100 to confirm whether the power source of the television 300 is in the power-on state after transmitting the CEC command to the television 300 to cause the television 300 to display the video data supplied from the camera 100. In the present exemplary embodiment, the CPU 101 performs the second power status confirmation process before the camera 100 transmits the video data to the television 300.

The second power status confirmation process is described in detail below.

If the second power status confirmation process is performed by the CPU 101, the process proceeds from step S316 to step S317.

In step S317, the CPU 101 changes the setting state of the power status confirmation flag f from ON to OFF in the memory 102. After the power status confirmation flag f is changed to OFF in the memory 102, the CPU 101 terminates the process of the flowchart illustrated in FIG. 3.

In the present exemplary embodiment, the CPU 101 performs the processes in step S301 to step S303 to acquire the logical address of the camera 100 and then performs the processes in step S304 to step S307 to acquire the physical address of the camera 100. Alternatively, the CPU 101 can perform the processes in step S304 to step S307 to acquire the physical address of the camera 100 and subsequently perform the processes in step S301 to step S303 to acquire the logical address of the camera 100. Further, the CPU 101 can perform the processes in step S304 to step S307 in parallel with the processes in step S301 to step S303 to acquire the logical address and the physical address simultaneously.

As another exemplary embodiment, the CPU 101 can control the command processing unit 103d to transmit a <Text View On> command to the television 300 in step S311, instead of transmitting the <Image View On> command. The <Text View On> command is one of the CEC commands, which is a command usable to bring the television 300 into the power-on state so that the video data can be displayed on the display unit 304 of the television 300.

Further, as another exemplary embodiment, the CPU 101 can confirm information that the communication unit 103 can detect via a clock line included in the TMDS line 203 before transmitting the video data in step S314.

The information that the communication unit 103 can detect via the clock line included in the TMDS line 203 is generally referred to as “RxSense.” The communication unit 103 can detect an H-level RxSense or an L-level RxSense.

As another exemplary embodiment, if the operational mode of the camera 100 is the playback mode, the camera 100 can perform the video switching process at timing when the HDMI cable 200 is connected to the connection terminal of the communication unit 103. Further, the camera 100 can perform the video switching process at timing when the camera 100 starts a playback operation in a state where the camera 100 can communicate with the television 300 via the HDMI cable 200.

Any other method is employable for the CPU 101 to acquire the logical address of the camera 100 instead of performing the above-described processes in step S301 to step S303. Further, any other method is employable for the CPU 101 to acquire the physical address of the camera 100 instead of performing the above-described processes in step S304 to step S307.

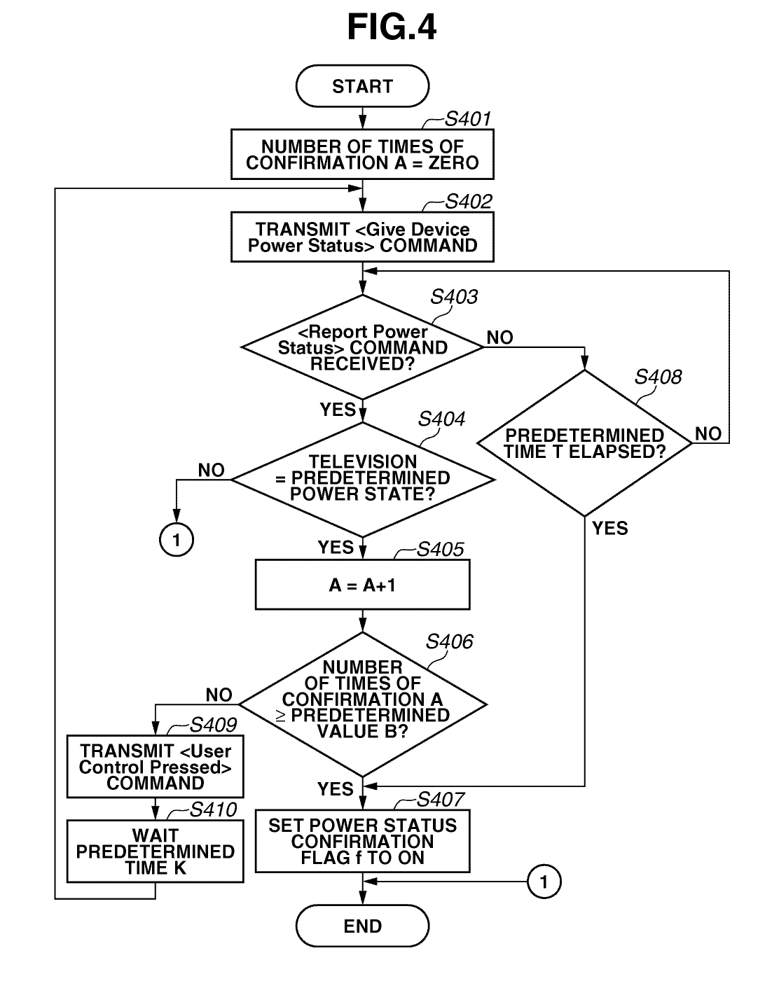

Next, the first power status confirmation process (i.e., the process to be performed in step S310 of the video switching process illustrated in FIG. 3) is described below with reference to FIG. 4. FIG. 4 is a flowchart illustrating an example of the first power status confirmation process that can be performed by the camera 100 according to the present exemplary embodiment. In the following description, the first power status confirmation process may be referred to as “first process.”

In step S401, the CPU 101 performs a process of resetting the number of times of confirmation A to zero (i.e., A=0). The number of times of confirmation A can be stored in the memory 102. The number of times of confirmation A indicates the number of times that the camera 100 has detected a predetermined power state of the television 300. The predetermined power state of the television 300 is either the standby state or a transition from the power-on state to the standby state in the operation thereof. If the number of times of confirmation A is reset, the process proceeds from step S401 to step S402 in the flowchart illustrated in FIG. 4.

In step S402, the CPU 101 controls the command processing unit 103d to transmit a <Give Device Power Status> command to the television 300 via the CEC line 204.

The <Give Device Power Status> command is one of the CEC commands, which is a command usable to request the television 300 to report a power state of the television 300.

Further, the CPU 101 controls a timer 101a to measure the time elapsed after the command processing unit 103d has transmitted the <Give Device Power Status> command. Information indicating the time measured by the timer 101a can be stored in the memory 102.

If the <Give Device Power Status> command is transmitted by the command processing unit 103d to the television 300 via the CEC line 204, the process proceeds from step S402 to step S403.

When the television 300 receives the <Give Device Power Status> command, the television 300 transmits a <Report Power Status> command to the camera 100 in response to the <Give Device Power Status> command. The <Report Power Status> command is one of the CEC commands, which is a command usable to report the power state of the television 300. The <Report Power Status> command includes information indicating the power state of the television 300.

The information indicating the power state of the television 300 includes information indicating the power-on state, information indicating a transition from the standby state to the power-on state, information indicating the standby state, and information indicating a transition from the power-on state to the standby state.

The CPU 101 identifies the power state of the television 300 with reference to the information indicating the power state of the television 300 included in the <Report Power Status> command.

Hence, in step S403, the CPU 101 determines whether the command processing unit 103d has received the <Report Power Status> command from the television 300.

If the CPU 101 determines that the command processing unit 103d has not received the <Report Power Status> command from the television 300 (NO in step S403), the process proceeds from step S403 to step S408.

If the CPU 101 determines that the command processing unit 103d has received the <Report Power Status> command from the television 300 (YES in step S403), the process proceeds from step S403 to step S404.

When the command processing unit 103d has received the <Report Power Status> command from the television 300, the command processing unit 103d supplies the received <Report Power Status> command to the CPU 101.

The CPU 101 analyzes the supplied <Report Power Status> command and stores an analysis result of the <Report Power Status> command in the memory 102. In this case, the CPU 101 controls the timer 101a to stop the time measurement having started in step S402. The CPU 101 deletes information indicating the time measured by the timer 101a in step S402 from the memory 102.

In step S404, the CPU 101 determines whether the television 300 is in the predetermined power state based on the analysis result of the <Report Power Status> command stored in the memory 102 in step S403.

The CPU 101 acquires information indicating the power state included in the <Report Power Status> command from the analysis result of the <Report Power Status> command. Hence, the CPU 101 determines whether the television 300 is in the predetermined power state with reference to the acquired information indicating the power state.

If the information indicating the power state included in the <Report Power Status> command is information indicating the power-on state, the CPU 101 determines that the television 300 is in the power-on state. In this case, the CPU 101 determines that the television 300 is not in the predetermined power state.

If the information indicating the power state included in the <Report Power Status> command is information indicating a transition from the standby state to the power-on state, the CPU 101 determines that the television 300 is in a transitional phase from the standby state to the power-on state. In this case, the CPU 101 determines that the television 300 is not in the predetermined power state.

If the information indicating the power state included in the <Report Power Status> command is information indicating the standby state, the CPU 101 determines that the television 300 is in the standby state. In this case, the CPU 101 determines that the television 300 is in the predetermined power state.

If the information indicating the power state included in the <Report Power Status> command is information indicating a transition from the power-on state to the standby state, the CPU 101 determines that the television 300 is in a transitional phase from the power-on state to the standby state. In this case, the CPU 101 determines that the television 300 is in the predetermined power state.

If the CPU 101 determines that the television 300 is in the predetermined power state (YES in step S404), the process proceeds from step S404 to step S405.

If the CPU 101 determines that the television 300 is not in the predetermined power state (NO in step S404), the CPU 101 terminates the process of the flowchart illustrated in FIG. 4.

When the CPU 101 determines that the television 300 is not in the predetermined power state (NO in step S404), the power state of the television 300 is the power-on state or the transitional phase from the standby state to the power-on state. In this case, the camera 100 confirms that the television 300 can display video data transmitted from the camera 100. Therefore, the CPU 101 causes the television 300 to display the video data transmitted from the camera 100 to the television 300 by executing the processes of step S311 to step S314 illustrated in FIG. 3.

When the television 300 is in the transitional phase from the standby state to the power-on state, the CPU 101 can control the video transmission unit 103c to transmit the video data to the television 300 after the time elapsed to bring the television 300 into the power-on state.

The time elapsed to bring the television 300 into the power-on state can be time information stored beforehand in the memory 102 of the camera 100 or can be time information obtainable by the camera 100 from the television 300.

In step S405, the CPU 101 increments the number of times of confirmation A stored in the memory 102 by one (i.e., A=A+1). In this case, the process proceeds from step S405 to step S406.

In step S406, the CPU 101 determines whether the number of times of confirmation A is equal to or greater than a predetermined value B. The predetermined value B is an arbitrary value that is equal to or greater than 2 and can be a threshold value stored beforehand in the memory 102 or a value that can be changed by a user.

If the CPU 101 determines that the number of times of confirmation A is less than the predetermined value B (NO in step S406), the process proceeds from step S406 to step S409.

If the CPU 101 determines that the number of times of confirmation A is equal to or greater than the predetermined value B (YES in step S406), the process proceeds from step S406 to step S407.

In step S407, the CPU 101 sets the power status confirmation flag f stored in the memory 102 to ON. Thus, the CPU 101 performs the second power status confirmation process in step S316 illustrated in FIG. 3. After the power status confirmation flag f is changed to ON in the memory 102, the CPU 101 terminates the process of the flowchart illustrated in FIG. 4. In this case, the CPU 101 performs the process of resetting the number of times of confirmation A stored in the memory 102.

In step S408, the CPU 101 determines whether the time measured by the timer 101a after the command processing unit 103d has transmitted the <Give Device Power Status> command in step S402 has exceeded a predetermined time T.

If the CPU 101 determines that the time measured by the timer 101a has not yet exceeded the predetermined time T (NO in step S408), the process returns from step S408 to step S403.

If the CPU 101 determines that the time measured by the timer 101a has exceeded predetermined time T (YES in step S408), the process proceeds from step S408 to step S407. In this case, in step S407, the CPU 101 sets the power status confirmation flag f stored in the memory 102 to ON, similar to the case where it is determined that the number of times of confirmation A is equal to or greater than the predetermined value B (YES in step S406).

In step S409, the CPU 101 controls the command processing unit 103d to transmit a <User Control Pressed> command to the television 300 via the CEC line 204.

The <User Control Pressed> command is one of the CEC commands, which is a command usable when the camera 100 controls the television 300 to bring the television 300 into the power-on state. The <User Control Pressed> command includes instruction information for bringing the television 300 into the power-on state.

Further, the CPU 101 controls the timer 101a to measure the time elapsed after the command processing unit 103d has transmitted the <User Control Pressed> command. Information indicating the time measured by the timer 101a can be stored in the memory 102.

If the <User Control Pressed> command is transmitted by the command processing unit 103d to the television 300 via the CEC line 204, the process proceeds from step S409 to step S410.

When the television 300 has received the <User Control Pressed> command transmitted from the camera 100 in step S409, the CPU 301 controls the power supply unit 307 to bring the television 300 into the power-on state.

Hence, in step S410, the CPU 101 controls the command processing unit 103d to wait for a while until the television 300 is brought into the power-on state according to the <User Control Pressed> command.

In this case, the CPU 101 controls the command processing unit 103d to wait for a while until the time elapsed after the command processing unit 103d has transmitted the <User Control Pressed> command in step S409 reaches a predetermined time K.

In the waiting state, the CPU 101 permits the command processing unit 103d to transmit a CEC command to the television 300 and receive a CEC command from the television 300. However, the CPU 101 prevents the command processing unit 103d from transmitting the <Give Device Power Status> command to the television 300.

If the CPU 101 determines that the time measured by the timer 101a after transmitting the <User Control Pressed> command by the command processing unit 103d has reached the predetermined time K, the CPU 101 determines that the predetermined time K has elapsed. In this case, the process returns from step S410 to step S402.

The predetermined time K can be time information stored beforehand in the memory 102 or can be time information changeable by a user. The predetermined time K can be any time required for the television 300 that has received the <User Control Pressed> command to control the power state of the television 300 according to the <User Control Pressed> command.

In this case, the CPU 101 can control the display unit 106 to display information required for a user to turn on the power source of the television 300 so that video data transmitted from the camera 100 to the television 300 can be displayed on the display unit 304 of the television 300.

Further, for example, if the determination result in step S406 is YES, the CPU 101 can control the display unit 106 to display information required for a user to turn on the power source of the television 300. Further, for example, if the determination result in step S408, the CPU 101 can control the display unit 106 to display information required for a user to turn on the power source of the television 300. Further, for example, in step S410, the CPU 101 can control the display unit 106 to display information required for a user to turn on the power source of the television 300.

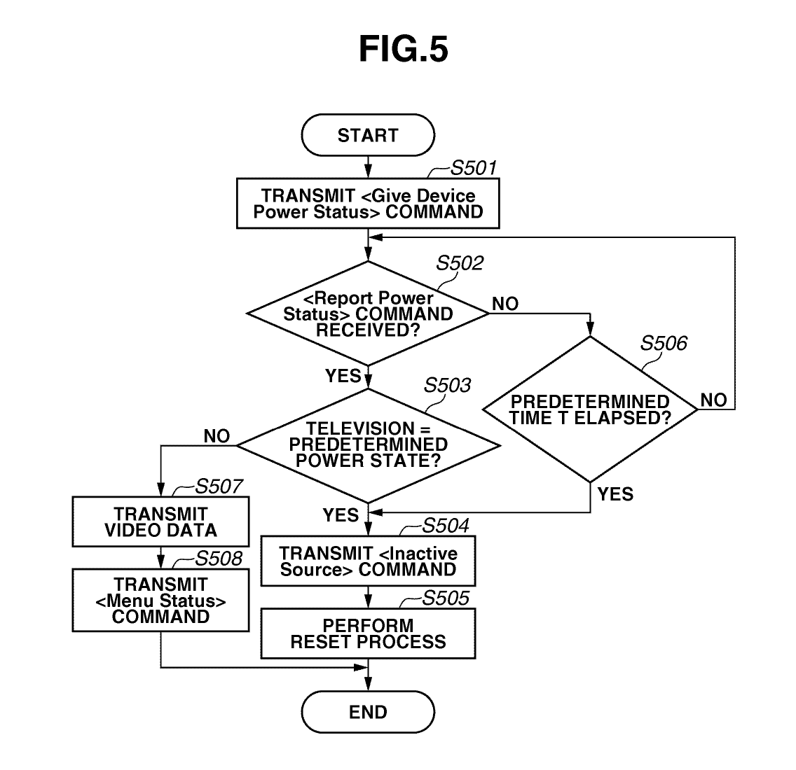

Next, the second power status confirmation process to be performed in step S316 of the video switching process in FIG. 3 is described in detail with reference to FIG. 5. FIG. 5 is a flowchart illustrating an example of the second power status confirmation process that can be performed by the camera 100 according to the present exemplary embodiment.

In step S501, the CPU 101 controls the command processing unit 103d to transmit the <Give Device Power Status> command to the television 300 via the CEC line 204, similar to step S402.

Further, the CPU 101 controls the timer 101a to measure the time elapsed after the command processing unit 103d has transmitted the <Give Device Power Status> command. Information indicating the time measured by the timer 101a can be stored in the memory 102.

If the <Give Device Power Status> command is transmitted by the command processing unit 103d to the television 300 via the CEC line 204, the process proceeds from step S501 to step S502 in the flowchart illustrated in FIG. 5.

In step S502, the CPU 101 determines whether the command processing unit 103d has received the <Report Power Status> command from the television 300, similar to step S403.

If the CPU 101 determines that the command processing unit 103d has not received the <Report Power Status> command from the television 300 (NO in step S502), the process proceeds from step S502 to step S506.

If the CPU 101 determines that the command processing unit 103d has received the <Report Power Status> command from the television 300, the CPU 101 analyzes the received <Report Power Status> command. The CPU 101 stores an analysis result of the <Report Power Status> command in the memory 102. If the CPU 101 determines that the command processing unit 103d has received the <Report Power Status> command from the television 300 (YES in step S502), the process proceeds from step S502 to step S503. In this case, the CPU 101 controls the timer 101a to stop the time measurement having started in step S501. The CPU 101 deletes information indicating the time measured by the timer 101a in step S501 from the memory 102.

In step S503, the CPU 101 determines whether the television 300 is in the predetermined power state based on the analysis result of the <Report Power Status> command stored in the memory 102 in step S502, similar to step S404.

If the CPU 101 determines that the television 300 is in the predetermined power state (YES in step S503), the process proceeds from step S503 to step S504.

If the CPU 101 determines that the television 300 is not in the predetermined power state (NO in step S503), the process proceeds from step S503 to step S507.

If the CPU 101 determines that the television 300 is in the predetermined power state (YES in step S503), the television 300 is in the standby state or in the transitional phase from the power-on state to the standby state. In this case, the CPU 101 determines that the television 300 cannot display video data transmitted from the camera 100.

Hence, in step S504, the CPU 101 controls the command processing unit 103d to transmit an <Inactive Source> command including the physical address of the camera 100 via the CEC line 204 to the television 300.

The <Inactive Source> command is one of the CEC commands, which is a command usable to notify each apparatus existing in the communication system of information indicating that the <Active Source> command transmitted from the camera 100 to the television 300 is invalid.

When the CPU 301 has received the <Inactive Source> command, the CPU 301 controls the operations of the television 300 to restore a previous state where the <Active Source> command is not yet received from the camera 100. In this case, the CPU 301 controls the communication unit 303 to return the connection terminal of the television 300 selected according to the <Active Source> command to the previous state where the <Active Source> command is not yet received.

If the <Inactive Source> command is transmitted by the command processing unit 103d to the television 300 via the CEC line 204, the process proceeds from step S504 to step S505.

In step S505, the CPU 101 performs a reset process. The reset process includes a process of deleting the information acquired by the camera 100 via the CEC line 204 from the television 300 and a process of initializing the command processing unit 103d.

The information to be deleted from the memory 102 by the CPU 101 includes the logical address of the camera 100, the CEC command received from the television 300, and information relating to the CEC command received from the television 300. Thus, the CPU 101 completes the process of deleting the information acquired by the camera 100 via the CEC line 204 from the television 300. The information relating to the CEC command received from the television 300 includes the analysis result of the CEC command that the command processing unit 103d has received from the television 300 and the information derived from the analysis result of the CEC command.

Further, the CPU 101 controls the power supply unit 108 to temporarily stop the electric power being currently supplied to the command processing unit 103d, and controls the power supply unit 108 to supply electric power to the command processing unit 103d again. In other words, the CPU 101 disconnects the communication between the command processing unit 103d and the television 300 via the CEC line 204 and initializes the command processing unit 103d.

Even when the reset process is performed by the CPU 101, the communication unit 103 continuously supplies electric power of +5V to the television 300 via the +5V power line and the HPD detection unit 103a continuously detects the HPD signal. Even when the reset process is performed by the CPU 101, the power supply unit 108 does not stop supplying electric power to the HPD detection unit 103a, the EDID acquisition unit 103b, and the video transmission unit 103c.

If the reset process is performed by the CPU 101, the CPU 101 terminates the process of the flowchart illustrated in FIG. 5.

When the reset process is executed in step S505, the CPU 101 can perform the process of step S301 (i.e., the video switching process illustrated in FIG. 3) again. In this case, if an H-level HPD signal is detected by the HPD detection unit 103a, the CPU 101 can execute only the processes in steps S301 to S303 and steps S308 to S317 (i.e., a part of the video switching process) while skipping the processes in step S304 to step S307. Further, before restarting the process in step S301, the CPU 101 can control the display unit 106 to display information required for a user to turn on the power source of the television 300.

In step S506, the CPU 101 determines whether the time measured by the timer 101a after the command processing unit 103d has transmitted the <Give Device Power Status> command in step S501 has exceeded the predetermined time T.

If the CPU 101 determines that the time measured by the timer 101a has not yet exceeded the predetermined time T (NO in step S506), the process returns from step S506 to step S502.

If the CPU 101 determines that the time measured by the timer 101a has exceeded the predetermined time T (YES in step S506), the process proceeds from step S506 to step S504.

In this case, similar to the case where the television 300 is in the predetermined power state (YES in step S503), in step S504, the CPU 101 transmits the <Inactive Source> command including the physical address of the camera 100 to the television 300.

In step S507, the CPU 101 controls the video transmission unit 103c to transmit the video data from the camera 100 to the television 300 via the TMDS line 203, similar to step S314.

After the video transmission unit 103c has started transmitting the video data to the television 300, the process proceeds from step S507 to step S508.

In step S508, the CPU 101 controls the command processing unit 103d to transmit the <Menu Status> command to the television 300 via the CEC line 204, similar to step S315.

After the <Menu Status> command is transmitted by the command processing unit 103d to the television 300 via the CEC line 204, the CPU 101 terminates the process of the flowchart illustrated in FIG. 5.

Further, the CPU 101 can perform the process of confirming the RxSense before transmitting the video data in step S507.

In the present exemplary embodiment, the camera 100 can transmit only audio data to the television 300 instead of transmitting video data to the television 300.

The communication apparatus 100 according to the present exemplary embodiment confirms the status of the power source of the external apparatus 300, before controlling the external apparatus 300 to display video data transmitted from the communication apparatus 100.

In this case, if the power source of the external apparatus 300 is in a state where video data transmitted from the communication apparatus 100 can be displayed, the communication apparatus 100 controls the external apparatus 300 to display video data received from the communication apparatus 100 and transmit the video data to the external apparatus 300.

Further, if the power source of the external apparatus 300 is in a state where video data transmitted from the communication apparatus 100 cannot be displayed, the communication apparatus 100 controls the external apparatus 300 to display video data received from the communication apparatus 100 and confirms the status of the power source of the external apparatus 300. In this case, the communication apparatus 100 transmits the video data to the external apparatus 300 after the communication apparatus 100 has determined that the power source of the external apparatus 300 is in a state where the video data transmitted from the communication apparatus 100 can be displayed.

Further, the communication apparatus 100 does not transmit the video data to the external apparatus 300 if the power source of the external apparatus 300 is in a state where the video data transmitted from the communication apparatus 100 cannot be displayed.

As described above, the communication apparatus 100 according to the present exemplary embodiment transmits video data to be displayed by the external apparatus 300 to the external apparatus 300 after confirming that the power source of the external apparatus 300 is in a state where the video data transmitted from the communication apparatus 100 can be displayed.

Therefore, the communication apparatus 100 can prevent the video data to be displayed by the external apparatus 300 from being transmitted to the external apparatus 300 if the power source of the external apparatus 300 is not in the state where the video data transmitted from the communication apparatus 100 can be displayed.

Thus, a user does not miss a chance to view the video data transmitted from the communication apparatus 100 to the external apparatus 300. The user can surely view any desired video data.

In the present exemplary embodiment, the camera 100 and the television 300 can communicate with each other according to the HDMI standard. However, the camera 100 and the television 300 can communicate with each other according to the Digital Interface for Video and Audio (DiiVA) standard.

The communication apparatus according to the present invention is not limited to the communication apparatus 100 in the above-described exemplary embodiment. Further, the external apparatus according to the present invention is not limited to the external apparatus 300 in the above-described exemplary embodiment. For example, the communication apparatus according to the present invention can be realized by a system including a plurality of apparatuses. The external apparatus according to the present invention can be realized by a system including a plurality of apparatuses.

Further, various processes and functions described in the above-described exemplary embodiment can be realized by executing a computer program. In this case, the computer program according to the present invention can be executed by a computer (including a CPU)) to realize various functions of the above-described exemplary embodiment.

The computer program according to the present invention can realize various processes and functions described in the above-described exemplary embodiment using an operating system (OS) running on the computer.

The computer program according to the present invention can be loaded from a computer-readable recording medium and can be executed by a computer. The computer-readable recording medium can be a hard disk drive, an optical disc, a Compact Disc Read Only Memory (CD-ROM), a Compact Disc Recordable (CD-R), a memory card, or a ROM. Further, the computer program according to the present invention can be supplied from an external apparatus to a computer via a communication interface and can be executed by the computer.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-021187 filed Feb. 2, 2011, which is hereby incorporated by reference herein in its entirety.

What is claimed is:

1. A communication apparatus comprising:
a first unit that transmits predetermined data to an external apparatus;
a second unit that transmits a command to the external apparatus; and
a control unit that controls the second unit to transmit a first command and a second command to the external apparatus,
wherein, if it is detected that the external apparatus is not in a power-on state, the control unit controls the first unit not to transmit the predetermined data to the external apparatus until the external apparatus is in the power-on state,
wherein, if it is detected that the external apparatus is in the power-on state, the control unit controls the first unit to transmit the predetermined data to the external apparatus after the second command is transmitted to the external apparatus,
wherein the predetermined data includes at least one of video data and audio data,
wherein the first command is used for detecting a power state of the external apparatus, and
wherein the second command is used for controlling the external apparatus to output the predetermined data supplied from the first unit to the external apparatus.

2. The communication apparatus according to claim 1, wherein, if it is detected that the external apparatus is not in a power-on state before the second command is transmitted to the external apparatus, the control unit controls the second unit to transmit a third command to the external apparatus, and wherein the third command is used for changing a power state of the external apparatus to the power-on state.

3. The communication apparatus according to claim 2, wherein, if it is detected that the external apparatus is not in the power-on state after the third command is transmitted to the external apparatus, the control unit controls the second unit to transmit the third command to the external apparatus.

4. The communication apparatus according to claim 2, wherein the third command includes a <User Control Pressed> command.

5. The communication apparatus according to claim 1, wherein, if it is detected that the external apparatus is not in the power-on state after the second command is transmitted to the external apparatus, the control unit controls the second unit to transmit a fourth command to the external apparatus, and wherein the fourth command is used for cancelling the second command.

6. The communication apparatus according to claim 5, wherein the fourth command includes an <Inactive Source> command.

7. The communication apparatus according to claim 1, wherein, if it is detected that the external apparatus is not in the power-on state after the second command is transmitted to the external apparatus, the control unit initializes the second unit without initializing the first unit.

8. The communication apparatus according to claim 1, wherein the first unit transmits the predetermined data to the external apparatus by using Transition Minimized Differential Signaling (TMDS).

9. The communication apparatus according to claim 1, wherein the second unit transmits the command to the external apparatus by using Consumer Electronics Control (CEC).

10. The communication apparatus according to claim 1, wherein the communication apparatus conforms to High-Definition Multimedia Interface (HDMI).

11. The communication apparatus according to claim 1, wherein the first command includes a <Give Device Power Status> command.

12. The communication apparatus according to claim 1, wherein the second command includes an <Active Source> command.

13. The communication apparatus according to claim 1, wherein, if the predetermined data is transmitted to the external apparatus, the control unit controls the second unit to transmit a fifth command to the external apparatus, and wherein the fifth command is used for operating the communication apparatus based on an operation unit used for operating the external apparatus.

14. A method for controlling a communication apparatus including a first unit that transmits predetermined data to an external apparatus and a second unit that transmits a command to the external apparatus, the method comprising:
controlling the second unit to transmit a first command to the external apparatus;
controlling the second unit to transmit a second command to the external apparatus;
controlling, if it is detected that the external apparatus is not in a power-on state, the first unit not to transmit the predetermined data to the external apparatus until the external apparatus is in the power-on state; and
controlling, if it is detected that the external apparatus is in the power-on state, the first unit to transmit the predetermined data to the external apparatus after the second command is transmitted to the external apparatus,
wherein the predetermined data includes at least one of video data and audio data,
wherein the first command is used for detecting a power state of the external apparatus, and
wherein the second command is used for controlling the external apparatus to output the predetermined data supplied from the first unit to the external apparatus.

15. A non-transitory computer readable recording medium storing a program that causes a computer to perform a method for controlling a communication apparatus including a first unit that transmits predetermined data to an external apparatus and a second unit that transmits a command to the external apparatus, the method comprising:
controlling the second unit to transmit a first command to the external apparatus;
controlling the second unit to transmit a second command to the external apparatus;
controlling, if it is detected that the external apparatus is not in a power-on state, the first unit not to transmit the predetermined data to the external apparatus until the external apparatus is in the power-on state; and
controlling, if it is detected that the external apparatus is in the power-on state, the first unit to transmit the predetermined data to the external apparatus after the second command is transmitted to the external apparatus,
wherein the predetermined data includes at least one of video data and audio data,
wherein the first command is used for detecting a power state of the external apparatus, and
wherein the second command is used for controlling the external apparatus to output the predetermined data supplied from the first unit to the external apparatus.
